(19) United States
(12) Patent Application Publication
(10) Pub. No.: US 2002/0069740 A1
(43) Pub. Date: Jun. 13, 2002

(54) Ticket destruction mechanism

(76) Inventor: Stephen P. Shoemaker JR., Redondo Beach, CA (US)

Correspondence Address: PRICE AND GESS, 2100 S.E. Main Street, Suite 250, Irvine, CA, 92614-6238, US

(21) Appl. No.: 10/023,372

(22) Filed: Dec. 13, 2001

Related U.S. Application Data
(60) Provisional application No. 60/255,637, filed on Dec. 13, 2000.

(51) Int. Cl. B26D 7/06

(52) U.S. Cl. 83/436.1; 83/407

(57) ABSTRACT

A ticket destruction mechanism for use with paper tickets comprises a ticket moving mechanism and a cutting mechanism disposed within a housing. The ticket moving mechanism carries paper tickets inserted into a slot in the housing from the slot to the cutting mechanism where they are destroyed. The ticket moving mechanism includes two continuous belts, each disposed around two rollers, with the two belts set parallel one another. In operation, the adjoining portions of each belt move together in the same direction to carry tickets towards the cutting mechanism. The cutting mechanism comprises a cutting gear configured to turn at a high rotation rate. At least one cutting blade is configured to protrude from the cutting gear. The cutting mechanism is set at a second end of the ticket moving mechanism, distal the slot in the housing. The cutting mechanism is oriented such that the protruding cutting blade will intersect a strip of tickets as it is fed out of the second end of the ticket moving mechanism. The rapidly rotating blade slices the paper tickets into many smaller pieces.

### CROSS REFERENCE TO RELATED APPLICATIONS

This application claims the benefit of U.S. Provisional Patent Application No. 60/255,637 filed on Dec. 13, 2000 and is incorporated herein by reference.

### BACKGROUND OF THE INVENTION

This application is directed to the destruction of tickets, primarily those dispensed by amusement games. It is often desirable to destroy such tickets after they have been redeemed to prevent them from being reused. While in some instances it may be cost-effective to reuse tickets, unauthorized reuse can result in lost profits. Unauthorized reuse can occur in numerous ways, however two are especially common. One common path to unauthorized reuse occurs when redeemed and discarded tickets are retrieved from the trash, perhaps by an opportunistic passer-by or one who deliberately goes searching through dumpsters. Another path to unauthorized reuse occurs when an employee deliberately intends to defraud the employer by collecting redeemed tickets to resell “under the table,” typically at a discount.

U.S. Pat. No. 5,211,093 issued to Homiak describes an apparatus that destroys tickets by slitting them in a lengthwise direction so that there are two separated halves that can not be reused. The tickets are destroyed by passing them under a rotary cutting disc. While this is effective, the strips remaining take up a lot of room in a cabinet or trash receptacle because the strips do not compact well under their own weight. The invention thus requires a large container to dispose of the numerous tickets halves deposited by customers.

U.S. Pat. No. 5,996,457 issued to Wingerton, Jr. advances on this technology of destruction by shearing the tickets into small bits. These pieces take up less space and the tickets are destroyed beyond any possible reconstruction or use. This is accomplished by passing the tickets through a slot in a drum-like enclosure. Inside the drum, a cutter rotates so that the tickets are sheared between the blade of the cutter and the housing.

While effective, reducing the tickets to shreds turns out to be very expensive and also creates considerable paper dust that can ultimately jam moving parts.

Both the Homiac and the Wingerton Jr. methods work well with card tickets, however neither is well suited for the newer type of ticket made of common paper. Since paper is much lighter than the pressed cardboard that has been previously used for amusement game (and other) tickets, a different technique for destroying paper tickets is required that will be both more effective and cheaper.

### BRIEF DESCRIPTION OF THE DRAWINGS

FIG. 1 is a side view of a ticket moving mechanism of the present invention;

FIG. 2 is a bottom view thereof;

FIG. 3 is side view of the cutter mechanism of the present invention; and

FIG. 4 is a top view of the cutter mechanism and the second end of the ticket moving mechanism.

### DETAILED DESCRIPTION OF THE PREFERRED EMBODIMENTS

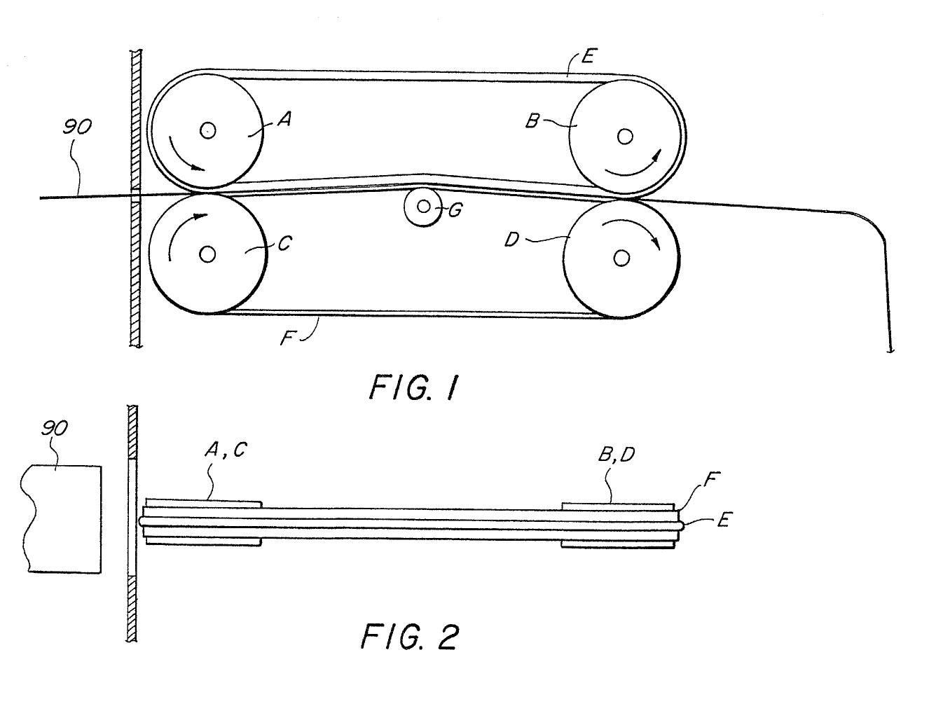

The present invention comprises a ticket moving mechanism and a cutting mechanism disposed within a housing. FIG. 1 shows a cross-section of the ticket moving mechanism, while FIG. 2 shows the ticket moving mechanism as viewed from below. The ticket moving mechanism comprises two flat belts E, F. At a first end of the ticket moving mechanism is a slot in the housing through which tickets to be destroyed can be inserted, and a sensor H (Not Shown) to detect their insertion. The ticket moving mechanism further comprises an idler roller G. The cutter mechanism is disposed at a second end of the ticket moving mechanism, distal the first end.

Belt E is configured to travel in a continuous—loop around two rollers A, B. Similarly, belt F is configured to travel in a continuous loop around two rollers C, D. Each belt E, F has a top portion and a bottom portion and are configured such that belt E is disposed above belt F. The bottom portion of belt E is set proximate to the top portion of belt F. Rollers A and B both rotate in a counter-clockwise direction such that belt E is continuously transported in the counter-clockwise direction. Similarly, rollers C and D both rotate in a clockwise direction such that belt F is continuously transported in the clockwise direction. Rollers A and C have substantially the same diameters and are equally geared such that a motor rotates both at substantially the same rate. Rollers C and D are not geared and rotate freely. These rollers are caused to rotate by their respective belts E, F. It will be apparent, therefore, that the bottom portion of belt E and the top portion of belt F move substantially together such that a fixed point on belt E and a fixed point on belt F that are proximate one another as they pass a line drawn between the axes of rollers A and C will still be substantially proximate one another as they reach a line drawn between the axes of rollers B and D. In the preferred embodiment belt E is approximately ⅛ inch wide, while belt F is approximately ⅜ to ½ inch wide. However, both belts E, F can be considerably wider and would still function adequately.

Additionally, idler roller G is disposed approximately midway between rollers C and D and presses against belt F so that belt F is pressed against belt E. An adjustable pressure P may also applied to roller A. In operation, a user feeds a strip of tickets into the slot in the housing proximate to the first side of the ticket moving mechanism. The sensor H, which can be an optical sensor, for example, detects the insertion of the tickets and starts the motor to rotate the belts. The inserted edge of the strip of tickets becomes pinched between belts E and F at a point between rollers A and C.

Adjusting pressure P allows the pinching force to be varied. Too low of a pinching force is undesirable as tickets may not be grabbed and transported between the belts E, F. Similarly, there is reason to avoid too high of a pinching force as ticket moving mechanism will grab the strip of tickets too forcefully. If the user doesn't release his grip of the strip of tickets, and the pinching force is too high, the strip of tickets will tend to separate at a pre-existing perforation between adjacent tickets. Thus, an optimum pinching force is low enough such that when a strip of tickets is disposed between belts E, F at the first end of the ticket moving mechanism and held by the user, the frictional forces applied by belts E, F against the strip will be insufficient to cause separation at a pre-existing perforation. An optimum pinching force will also be high enough, however, so that an unrestrained strip of tickets inserted by the user will be readily grabbed and transported at least as far as the idler roller G. Idler roller G, by virtue of the pressure maintained against the belts E, F keeps the belts E, F from vibrating apart from one another so that the strip of tickets is held securely and is continuously transported to the cutter mechanism.

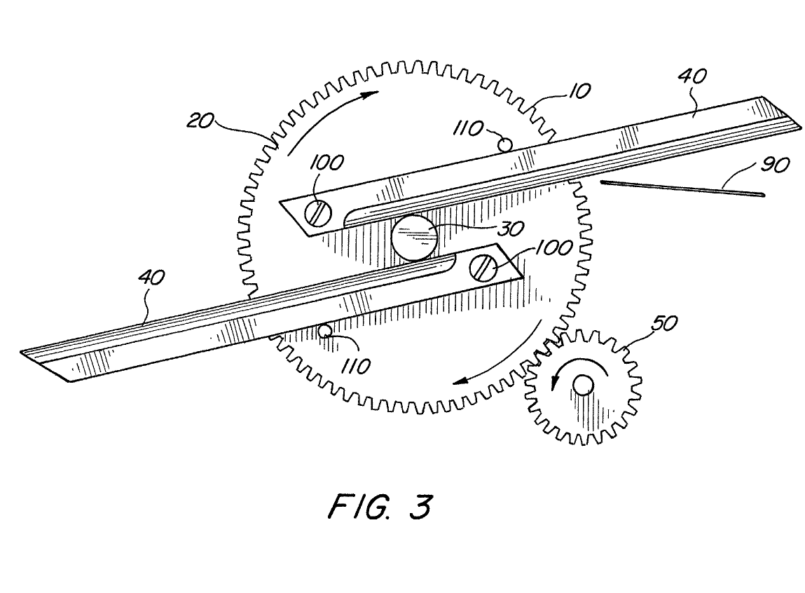

FIG. 3 shows a side view of the cutter mechanism 10. The cutter mechanism comprises a cutter gear 20 configured to rotate around a post 30 and at least one blade 40 fixed thereto. A second gear 50 attached to a motor 70 is configured to engage the cutter gear to cause it to rotate in the direction shown. The cutter mechanism further includes a ledge 80 set next to the cutter gear 20 that is oriented such that the rotating blade 40 passes proximate to a leading edge 60 thereof. The ledge 80 is further positioned at the second end of the ticket moving mechanism such that tickets 90 passing out from between the two belts E, F pass over the ledge 80.

In the preferred embodiment the cutter gear 20 further includes a pin 110 disposed proximate to the circumference of the cutter gear. The blade is attached to the cutter gear by a retaining screw 100 so that the blade 40 is held between the post 30 and the pin 110 as shown. The sharp edge of the blade 40 is oriented such that it leads as the cutter gear rotates. In the preferred embodiment, however, more than one blade is employed, as shown in FIG. 3, to balance the cutter gear to prevent vibrations. FIG. 3 shows two blades set opposite one another, though any number of evenly arranged blades can also be used.

In the preferred embodiment the blades are snap-off blades approximately ⅜ inch wide and 3 inches long, though it will be appreciated that other blades can also be used. Snap-off blades are preferred, however, as they are inexpensive and readily available. The blades will dull with use, typically after hundreds of thousands of cuts, but will still tend to tear the tickets rather than cleanly slice them. Just the same, the tickets are destroyed. Replacing blades is accomplished simply by removing the retaining screw 100. Fresh blades are preferred, however, as they tend to reduce the amount of dust produced by the cutting process. Accordingly, one advantage of the present invention is that it creates little dust, compared to the prior art.

The motor used to drive the cutter mechanism needs to be of sufficient strength to drive the blades through the ticket material. Thicker and wider tickets require a stronger motor than do thinner and narrower tickets. A rotation rate of 1000 RPM for the cutter gear is generally adequate for most tickets, however, faster rotation rates make for cleaner cuts and less dust.

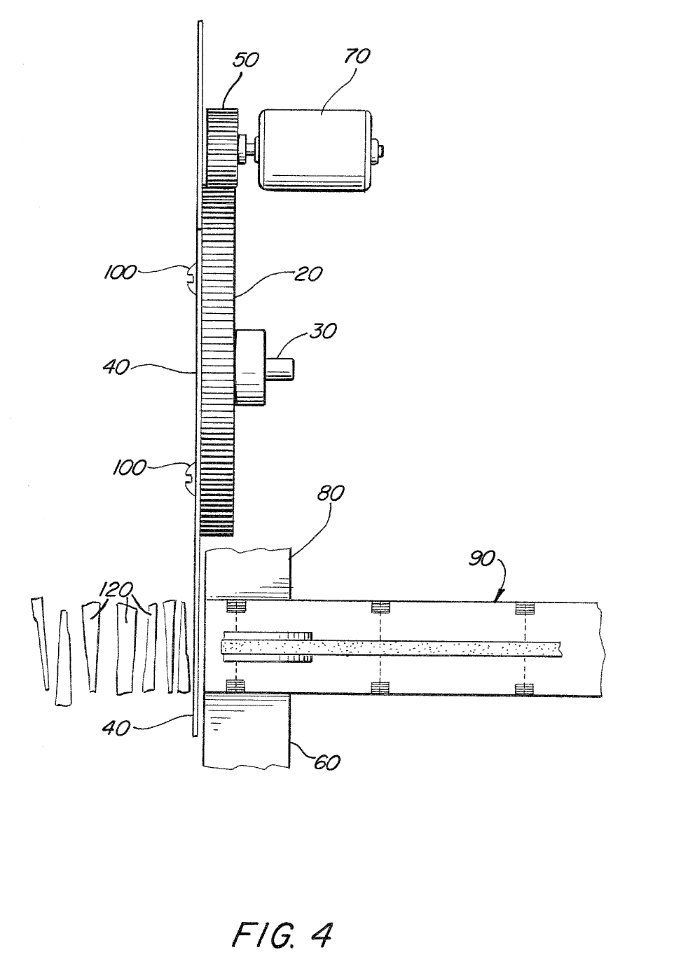

FIG. 4 shows a top view of the cutter mechanism 10 attached to the second end of the ticket moving mechanism. FIG. 4 additionally shows a strip of tickets being transported to the cutter mechanism and sliced into a plurality of pieces 120. It will be apparent that the size of the pieces will depend on the speed with which the tickets are transported to the cutter mechanism and the rotation rate of the cutter gear.

What is claimed is:

1. A ticket destruction mechanism comprising:
a housing including a slot;
a ticket moving mechanism set within said housing, said ticket moving mechanism having a first end proximate said slot and a second end distal said first end, said ticket moving mechanism including
a first continuous belt configured to run in a first continuous loop around first and second rollers, said first loop having a bottom segment;
a second continuous belt configured to run in a second continuous loop around third and fourth rollers, said second loop having a top segment, wherein said top segment of said second loop is set proximate to said bottom segment of said first loop;
a cutter mechanism set within said housing proximate said second end of said ticket moving mechanism, said cutter mechanism including a cutter gear having at least one blade extending therefrom, said cutter gear configured to rotate around an axis proximate said second end of said ticket moving mechanism.

2. The ticket destruction mechanism of claim 1 further including a sensor set within said housing proximate said first end of said ticket moving mechanism, said sensor being capable of sensing the insertion of a paper ticket through said slot in said housing in order to activate said ticket moving and cutting mechanisms.

3. The ticket destruction mechanism of claim 1 wherein said ticket moving mechanism further includes an idler roller disposed approximately midway between said third and fourth rollers and is configured to press against said second belt such that said second belt maintains continuous contact with said first belt at a point proximate said idler roller.

4. The ticket destruction mechanism of claim 1 wherein pressure is applied to said first roller such that a pinching force is maintained between said first and second belts between said first and third rollers.

5. The ticket destruction mechanism of claim 1 wherein said first and third rollers are geared together such that they rotate with a substantially same rate.

6. The ticket destruction mechanism of claim 1 wherein said at least one blade is two blades set opposite one another.
